(19) United States
(12) Patent Application Publication
(10) Pub. No.: US 2025/0287888 A1
(43) Pub. Date: Sep. 18, 2025

(54) ECO-FRIENDLY, SUSTAINABLE, LIGHTWEIGHT, POROUS CELLULOSE SPONGE FOR CROP GROWTH

(71) Applicant: ARIZONA BOARD OF REGENTS ON BEHALF OF THE UNIVERSITY OF ARIZONA, Tucson, AZ (US)

(72) Inventors: Minkyu Kim, Tucson, AZ (US); Zhu Zhao, Tucson, AZ (US); Samuel Kim, Tucson, AZ (US)

(21) Appl. No.: 19/081,965

(22) Filed: Mar. 17, 2025

Related U.S. Application Data
(60) Provisional application No. 63/566,125, filed on Mar. 15, 2024.

(51) Int. Cl. A01G 24/48; A01G 24/22; A01G 31/02; C08J 9/00

(52) U.S. Cl. CPC A01G 24/48; A01G 24/22; C08J 9/0023; A01G 31/02

(57) ABSTRACT

A cellulose sponge was developed with sustainability, food safety, high porosity with large pores, high water retention, durability, low density, and malleability. The cellulose sponge is formed by one or more cellulose derivatives cross-linked with citric acid. The sponge may be highly porous such that the sponge is configured to be suitable for supporting plant growth. A method for forming this cellulose sponge may comprise providing one or more cellulose derivatives and citric acid, dissolving the citric acid in water to create a citric acid solution, adding the one or more cellulose derivatives into the citric acid solution while stirring such that no clumps are formed to create a cellulose-citric acid solution, removing the water from the cellulose-citric acid solution, and cross-linking the cellulose-citric acid solution to create the sponge.

### CROSS-REFERENCE TO RELATED APPLICATIONS

This application is a non-provisional and claims benefit of U.S. Provisional Application No. 63/566,125 filed Mar. 15, 2024, the specification(s) of which is/are incorporated herein in their entirety by reference.

### STATEMENT REGARDING FEDERALLY SPONSORED RESEARCH OR DEVELOPMENT

This invention was made with government support under Grant No. 80NSSC20K1418 awarded by NASA. The government has certain rights in the invention.

### FIELD OF THE INVENTION

The present invention is directed to cellulose sponges implementing high porosity with large size pores, high water retention, durability, low density, and malleability for sustainability, food safety, and pick-and-eat crop growth implementations.

### BACKGROUND OF THE INVENTION

Space travel is unpredictable. From the nearly fatal poisonous gas leak on the Apollo-Soyuz test project in 1975 to the catastrophic Space Shuttle Columbia disaster in 2003, any scenario has the potential to play out. It is impossible to know what is to come, but to ensure specific disasters are mitigated, preemptive planning and testing are necessary.

Space exploration technology is rapidly advancing. In a matter of years, it is predicted that a manned spaceflight to Mars will become a reality. When considering the important factors for a successful multiple-month voyage to Mars, food and water are high on that list. If something goes wrong and the food supply of the astronauts runs low, they are likely to starve to death unless they have the ability to grow their own food. Plants consume valuable water so if the water supply begins to run low as well, the crew will be forced to choose between drinking water or growing food. Conventional plant growth methods on Earth cannot be directly applied in space. Specifically, (1) soil-based cultivation is effective but impractical for space missions due to its weight and transport limitations, and (2) Aquaponic or hydroponic systems work well on Earth but require additional methods to manage water retention and distribution in microgravity.

Plant-growing mediums in space undergo rigorous testing. One of the requirements for a material to be considered as a potential plant growth medium is it must be safe for the astronauts in space. Materials that are poisonous or otherwise harmful to the health of the crew are disqualified. For example, the popular plant growth material which goes by the name of Rockwool®. Rockwool® is molten rock that has been spun to create small fibers. Compared to soil or hydroponic systems, Rockwool® and cellulose sponge are light weight and can hold the water. On Earth, Rockwool® is a fantastic plant growth medium, but in space, Rockwool® poses a serious health hazard. The microgravity environment of space causes some materials like Rockwool® to suddenly become a serious health hazard. Rockwool®'s fine and flakey nature poses little threat to people on Earth because the fibers are pulled to the ground by gravity. In space, the fibers flake off and float around with ease. If inhaled, the fibers can cause irritation of the lungs and over time may cause various respiratory diseases. The best way to avoid the risk of inhaling these fibers is to avoid using materials like Rockwool® altogether. In response to NASA looking for a safe alternative to materials like Rockwool®, cellulose sponges were developed.

Cellulose is the most abundant natural biopolymer with a global reserve of up to 75 billion tons from a variety of sustainable sources such as wood, plants, and algae. Moreover, diverse cellulose derivatives are available by modifying hydroxyl groups (—OH) on the D-glucopyranose ring-based backbone. In addition, the hydroxyl groups contribute to forming hydrogen bonds with oxygen atoms on adjacent molecules, creating a water-retaining property. This alternative medium is non-toxic and poses no risk of flaking, which is a highly sought-after trait. Due to the safety profile of these biopolymers to humans and the environment, cellulose and its derivatives are widely used as a binder, thickener, emulsifier, and dispersing agent in various applications such as food, cosmetic and personal care, pharmaceutics, construction, and agriculture.

### BRIEF SUMMARY OF THE INVENTION

It is an objective of the present invention to provide a cellulose-based plant growth medium that allows for sustainability, food safety, high porosity with large size pores, high water retention, durability, low density, malleability, and pick-and-eat crop growth, as specified in the independent claims. Embodiments of the invention are given in the dependent claims. Embodiments of the present invention can be freely combined with each other if they are not mutually exclusive.

Cellulose sponges have been developed as an alternative medium to grow plants in extreme environments, such as space safely. The capability of cellulose sponges to grow plants on Earth has proven comparable to Rockwool®, which is the leading competitor in terms of plant growth. It was determined that the balance of hydrophilic and hydrophobic properties of the cellulose sponge was important for water retention and plant growth. Crosslinking density during the sponge preparation process was important for water absorption level as well as plant support. In particular, crosslinking was important for material integrity, especially in drought tests (e.g., during (re)hydration-dehydration cyclical testing). The cellulose sponge is expected to be used to grow fresh produce in extreme conditions, such as the ISS.

According to some embodiments, the present invention features a cellulose sponge for supporting plant growth. The cellulose sponge is a reaction product of cellulose or a cellulose derivative cross-linked with citric acid. In some embodiments, the ratio of cellulose or the cellulose derivative to the citric acid ranges from about 100:1 to about 1:1. In other embodiments, the sponge may comprise pores having a diameter ranging from about 0.01 mm to 1 mm, or greater than 1 mm. The sponge can have a porosity ranging from about 80% to about 95%. In other embodiments, the sponge can have a porosity of about 90% to about 95%.

In some embodiments, the cellulose derivative may comprise hydroxyethyl cellulose, hydroxyethyl methylcellulose, hydroxypropyl methylcellulose, or a combination thereof. In some embodiments, cellulose is crosslinked with citric acid. In other embodiments, a cellulose derivative is crosslinked with citric acid. Any citric acid may be used with the present invention. In some embodiments, the citric acid comprises food-grade citric acid. Food-grade citric acid may be used for growing plants, including vegetables.

In some embodiments, the density of the sponge ranges from about 17.6 to 130.7 kg/m³. In other embodiments, the sponge is configured to absorb water such that the weight of the sponge can expand by 3000% to 4000% over an hour. In some other embodiments, the sponge is configured to absorb water such that the weight of the sponge can expand by about 1000% to about 4000% over an hour. In some other embodiments, the lifespan of the sponge can be greater than one month. The cellulose sponge of the present invention was tested under severe conditions and demonstrated durability under harsher conditions-specifically, a 24-hour dehydration and 1-hour rehydration cycle repeated for one month.

According to other embodiments, the present invention provides a method of forming a cellulose sponge suitable for supporting plant growth. In a non-limiting embodiment, the method may comprise providing a cellulose or a cellulose derivative, providing a solution comprising citric acid and water, mixing cellulose or the cellulose derivative into the solution of citric acid and water to create a cellulose-citric acid solution, lyophilizing the cellulose-citric acid solution, and heating the lyophilized cellulose-citric acid mixture to cause cross-linking of the cellulose or cellulose derivative and citric acid, thereby producing the cellulose sponge. In some embodiments, the lyophilized cellulose-citric acid mixture is heated to a temperature ranging from about 120 to 200° C. for cross-linking. The method further comprises removing unreacted citric acid from the cellulose sponge. The unreacted citric acid can be removed by dialysis. In some other embodiments, the method further comprises lyophilizing the cellulose sponge to remove water. In some embodiments, the method further comprises heating the solution of citric acid and water to a temperature of about 60-80° C. while mixing in cellulose or the cellulose derivative. In some embodiments, the cellulose or cellulose derivative and solution of citric acid and water are stirred to prevent clumping.

For example, in a non-limiting embodiment, the sequence of steps is as follows:
1. Dissolve citric acid in water and add cellulose (or its derivatives).
2. Mix at either room temperature (RT) or 60-80° C.
3. Lyophilize the mixture.
4. Heat the lyophilized cellulose+citric acid mixture at high temperature for crosslinking, which becomes the cellulose sponge.
5. Dialyze the cellulose sponge in water to remove unreacted citric acid.
6. Lyophilize the final product.

According to other embodiments, the method may comprise providing one or more cellulose derivatives, providing a citric acid solution, mixing the one or more cellulose derivatives into the citric acid solution while stirring such that no clumps are formed to create a cellulose-citric acid solution, lyophilizing the cellulose-citric acid solution, and cross-linking the lyophilized cellulose-citric acid mixture to create the cellulose sponge. In some embodiments, lyophilizing the cellulose-citric acid solution may comprise freezing the cellulose-citric acid solution, placing the frozen cellulose-citric acid solution into a lyophilizer, actuating the lyophilizer, and freeze-drying or dehydrating the frozen cellulose-citric acid solution. In some embodiments, cross-linking the lyophilized cellulose-citric acid mixture may comprise heating the lyophilized cellulose-citric acid mixture to a temperature of 120 to 200° C. In some embodiments, the method may further comprise dialyzing the sponge to remove extra citric acid in the sponge since citric acid can reduce the pH later and negatively affect plant growth. Dialyzing may comprise hydrating the sponge in an aqueous solution, stirring the sponge at a steady stir rate, and straining the aqueous solution from the sponge. This step is repeated a few times to remove residual, uncrosslinked citric acids from the sponge which will then be lyophilized.

In some embodiments, the present invention also features a method for supporting plant growth in low-moisture environments. In some embodiments, the method may comprise providing a highly porous cellulose sponge formed by cellulose or one or more cellulose derivatives cross-linked with citric acid, placing the sponge into a vessel, placing one or more seeds into the vessel on top or right underneath the sponge, and adding a nutrient solution to the vessel such that the sponge is at least partially covered.

One of the unique and inventive technical features of the present invention is the ability of the sponge to retain water and rehydrate without losing structural integrity. The cellulose sponge is capable of full rehydration with little to no net shrinkage after experiencing complete dehydration. Without wishing to limit the invention to any theory or mechanism, it is believed that this technical feature of the present invention advantageously provides for a cellulose sponge that can thrive in drought conditions. This makes it ideal for growing crops in space because there are limited resources in space and the goal is to use as little water as possible. None of the presently known prior references or works have the unique inventive technical feature of the present invention.

Furthermore, the inventive technical feature of the present invention contributed to a surprising result. For example, during one of the experiments, the cellulose sponge was unexpectedly contaminated, but was still able to withstand extreme conditions and support life. Moreover, the cellulose sponge surprisingly performed better than Rockwool® during drought conditions. For instance, Rockwool® failed to provide water and nutrients to the plants soon after the full drought began. Rockwool® is porous but it does not retain water nearly as efficiently as the cellulose sponges.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A shows a flow chart of a method for forming a cellulose sponge suitable for supporting plant growth.

FIG. 1B shows a flow chart of a method for supporting plant growth through the use of a cellulose sponge.

FIG. 2 shows a diagram of materials processed to prepare the cellulose sponge of the present invention.

FIG. 3 shows a zoomed-in view of the porous structures in the cellulose sponge.

FIG. 4 shows a graph of the durability of the cellulose sponge of the present invention. A cyclical water dehydration-rehydration test was performed (n=3) to gather this data. Water swelling was calculated by subtracting the dried sponge weight from the wet sponge weight after 1 hour of hydration.

FIG. 5 shows the results of a plant germination test to evaluate the performance of the cellulose sponge of the present invention compared to commercially available Rockwool®.

FIG. 6 shows photos of lettuce root penetration through the cellulose sponge of the present invention.

FIG. 7 shows a crosslinking reaction of citric acid with hydroxyl groups in various cellulose and its derivatives, forming the cellulose sponge of the present invention.

FIG. 8 shows a sequence of photos of the trial 1 control group with no drought. 0.5--1 w/v % cellulose derivatives (e.g., HEC 5k, HEMC 30k) are mixed with 0.1 w/v % citric acid in water. For example, a mixture containing 1 w/v % HEC 5k and 0.1 w/v % citric acid is denoted as HEC 5k 1-0.1.

FIG. 9 shows a sequence of photos of the trial 1 slight drought group.

FIG. 10 shows a sequence of photos of the trial 1 large drought group.

FIG. 11 shows a graph of trial 1 data for a number of leaves for each sample.

FIG. 12 shows a graph of trial 1 data for the root length of each sample.

FIG. 13 shows a graph of trial 1 data for the leaf diameter of each sample.

FIG. 14 shows a sequence of photos of the trial 2 control group. Photos were taken every 5 days.

FIG. 15 shows a sequence of photos of the trial 2 slight drought group.

FIG. 16 shows a sequence of photos of the trial 2 large drought group.

FIG. 17 shows a graph of trial 2 data for the number of leaves for each sample.

FIG. 18 shows a graph of trial 2 data for root length for each sample.

FIG. 19 shows a graph of trial 2 data for leaf diameter for each sample.

FIG. 20 shows a sequence of photos of the trial 3 slight drought group.

FIG. 21 shows a sequence of photos of the trial 3 large drought group.

FIG. 22 shows a sequence of photos of the trial 3 extreme drought group.

FIG. 23 shows a graph of trial 3 data for the number of leaves for each sample.

FIG. 24 shows a graph of trial 3 data for root length for each sample.

FIG. 25 shows a graph of trial 3 data for leaf diameter for each sample.

FIG. 26 shows a sequence of photos of the first trial 4 control group.

FIG. 27 shows a sequence of photos of the second trial 4 control group.

FIG. 28 shows a sequence of photos of the first trial 4 drought group.

FIG. 29 shows a sequence of photos of the second trial 4 drought group.

FIG. 30 shows a graph of trial 4 data for a number of leaves for each sample.

FIG. 31 shows a graph of trial 4 data for root length for each sample.

FIG. 32 shows a graph of trial 4 data for leaf diameter for each sample.

### DETAILED DESCRIPTION OF THE INVENTION

Referring to the figures, the present invention features a highly porous, cellulose sponge suitable for supporting plant growth. The cellulose sponge (100) may be formed by cellulose or one or more cellulose derivatives (110) cross-linked with citric acid (120). Due to the high porosity, the roots of the plant are able to penetrate the sponge (100) such that the plant can be supported by the sponge (100) without the need for soil. In some embodiments, the one or more cellulose derivatives (110) may comprise hydroxyethyl cellulose, hydroxyethyl methylcellulose, hydroxypropyl methylcellulose, or a combination thereof. In some embodiments, the citric acid (120) may comprise food-grade citric acid (120). In some embodiments, a concentration of cellulose or the one or more cellulose derivatives (110) may be 0.1% to 15% of the weight per volume of the sponge (100). In some embodiments, a density of the sponge (100) may be 17.6 to 130.7 kg/m3.

In some embodiments, the sponge (100) may be configured to absorb water such that the weight of the sponge (100) expands by 3000% to 4000% over an hour. In other embodiments, the sponge (100) may be configured to absorb water such that the weight of the sponge (100) expands by 2000% to 3000% over an hour. In some other embodiments, the sponge (100) may be configured to absorb water such that the weight of the sponge (100) expands by 1000% to 2000% over an hour.

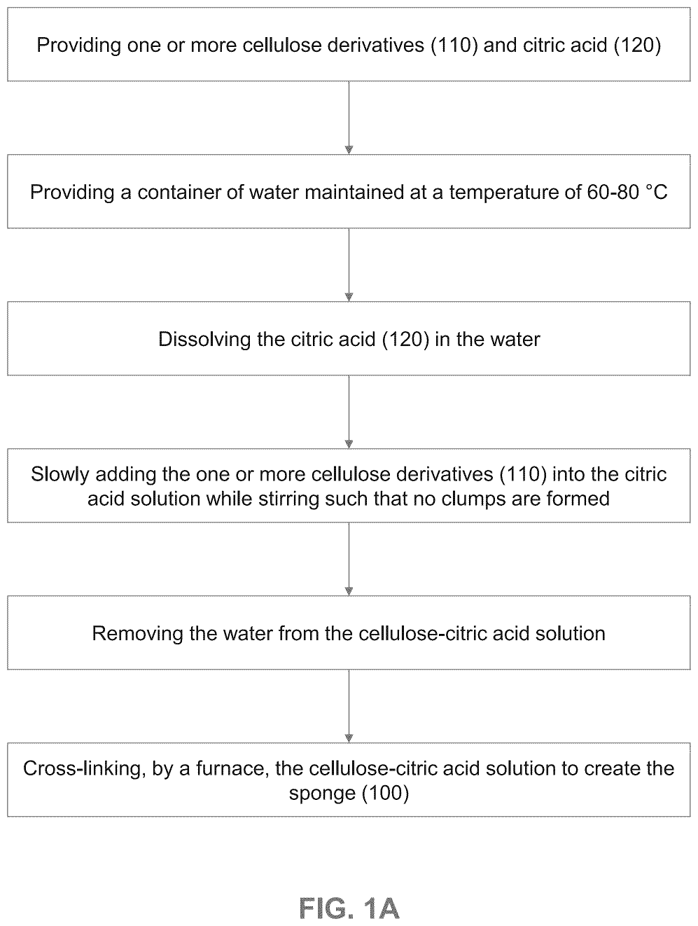

Referring now to FIG. 1A, the present invention features a method for forming a cellulose sponge (100) suitable for supporting plant growth. In some embodiments, the method may comprise providing one or more cellulose derivatives (110) and citric acid (120), providing a container of water maintained at a temperature of 60 to 80° C., dissolving the citric acid (120) in the water to create a citric acid solution, slowly adding the one or more cellulose derivatives (110) into the citric acid solution while stirring such that no clumps are formed to create a cellulose-citric acid solution, removing the water from the cellulose-citric acid solution via the lyophilization process, and cross-linking, by a furnace, the dried cellulose-citric acid mixture to create the sponge (100). In some embodiments, the furnace may be configured to maintain a temperature in the range of 120° C. to 200° C.

The temperature increase is intended to accelerate cellulose dissolution, though cellulose can still dissolve at room temperature at a slower rate.

In some embodiments, the method may further comprise dialyzing the sponge (100). In some embodiments, dialyzing may comprise sterilizing a beaker or bucket, filling the beaker or bucket with water, placing the dried sponge (100) in the beaker or bucket, stirring the water in the beaker or bucket at a steady stir rate, and straining the water from the beaker or bucket. This dialysis can be repeated 2-4 times to remove any residual citric acids that are unused during the cross-linking process. In some embodiments, the steady stir rate may be less than or equal to 160 rotations per minute. In some embodiments, removing the water from the cellulose sponge may comprise freezing the sponge by application of liquid nitrogen, placing the frozen cellulose sponge into a lyophilizer, actuating the lyophilizer such that the water is removed from the frozen sponge.

Referring now to FIG. 1B, the present invention features a method for supporting plant growth in low-moisture environments. In some embodiments, the method may comprise providing a highly porous cellulose sponge (100) formed by one or more cellulose derivatives (110) cross-linked with citric acid (120), placing the sponge (100) into a vessel, placing one or more seeds into the vessel on top or right underneath the surface of the sponge (100), and adding a nutrient solution to the vessel such that the sponge (100) is at least partially covered.

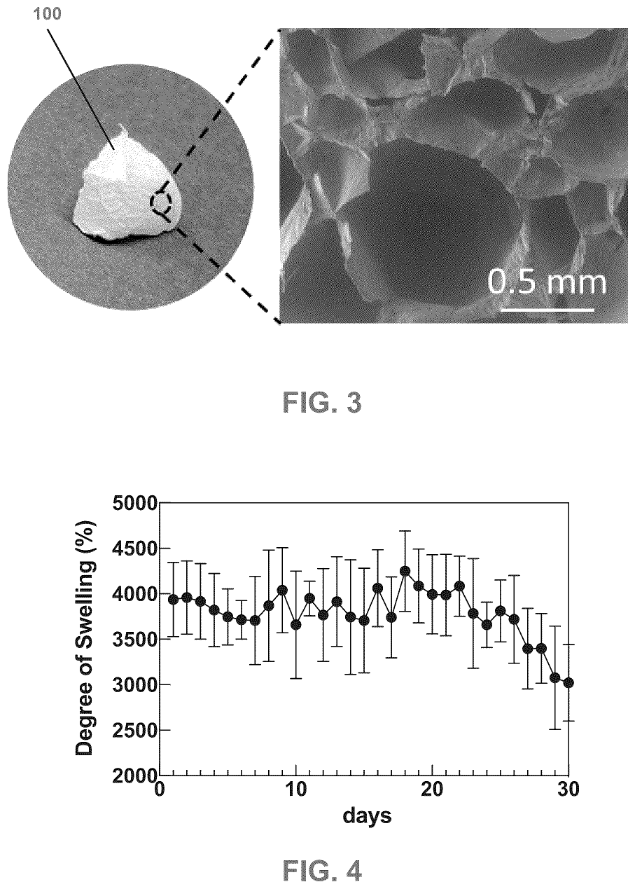

In some embodiments, a lifespan of the sponge (100) under constant moisture may be greater than 1 month. FIG. 4 presents the (re)hydration-dehydration cyclic testing, demonstrating a lifespan of one month. Given that this test involves extreme conditions, specifically, a 24-hour dehydration and 1-hour rehydration cycle repeated for one month, then maintaining constant moisture should result in a significantly longer lifespan.

In some embodiments, the sponge of the present invention may be highly porous. As used herein, porosity is a percentage of the void in the cellulose sponge, derived from the ratio of the volume of the voids to the total volume. Thus, a high porosity will have greater void volume. In some embodiments, the cellulose sponge of the present invention may have a porosity of about 90% to 95%. In other embodiments, the cellulose sponge of the present invention may have a porosity of about 85% to 90%. In other embodiments, the cellulose sponge of the present invention may have a porosity of about 80% to 85%. In some embodiments, the cellulose sponge of the present invention may have a porosity of greater than 95%.

### EXAMPLES

The following are non-limiting examples of the present invention. It is to be understood that said examples are not intended to limit the present invention in any way. Equivalents or substitutes are within the scope of the present invention.

EXAMPLE 1: Food-grade cellulose derivatives were crosslinked with food-grade citric acid to construct sponges with high water-retention properties. This cellulose sponge was buried under the soil and successfully grew a plant with the benefit of providing water and nutrients longer than just the soil itself. Although direct plant growth on cellulose materials without soil would be more convenient, the small pores in the cellulose sponge prevent the roots from penetrating through and thus, a plant-supporting system, such as soil, is required. To overcome this challenge and simplify the cellulose-based plant growth system, we controlled the component-structure-property-processing of cellulose materials for plant growth without soil. Furthermore, by testing diverse cellulose derivatives, we identified the best performers to grow pick-and-eat crops, such as lettuce. Without wishing to limit the present invention to a particular theory or mechanism, unmodified cellulose sponges had pores too small and needed soil, whereas improved sponges with larger pores do not need soil. The key difference in the present invention is the inclusion of a lyophilization process, which enables the formation of larger pores in the cellulose material, thus offering advantages such as prolonged water retention and improved root penetration. This may be particularly beneficial in semi-arid and arid conditions.

Cross-linked cellulose (derivatives) using citric acid: High concentrations of cellulose and cellulose derivatives in aqueous buffers can form sponges through non-covalent interactions between cellulose network strands. However, non-covalently associated sponge can eventually lose its structure because the concentration can go lower when the water is frequently delivered to the system. Moreover, if the system is completely dehydrated, the original structure cannot be recovered although the water is re-applied. To avoid these situations, over-the-counter citric acid was used which can permanently connect hydroxyl groups in cellulose and cellulose derivatives. This cross-linked cellulose approach overcame the dilution and structural integrity issues.

High porosity with large size pores: High porosity with large pore sizes improves oxygen delivery and is necessary for the roots to penetrate the material, which provides support for the plant. To prepare cross-linked cellulose with high porosity and large pore sizes, a freeze-drying process was used. This involved freezing a mixture of cellulose, citric acid, and water, followed by applying a vacuum at low temperatures to sublimate the ice, creating a structure with many and large pores.

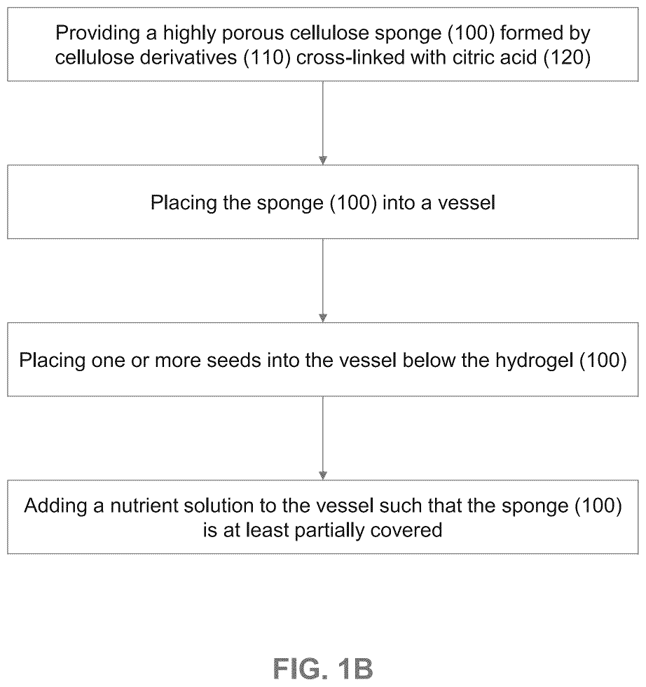

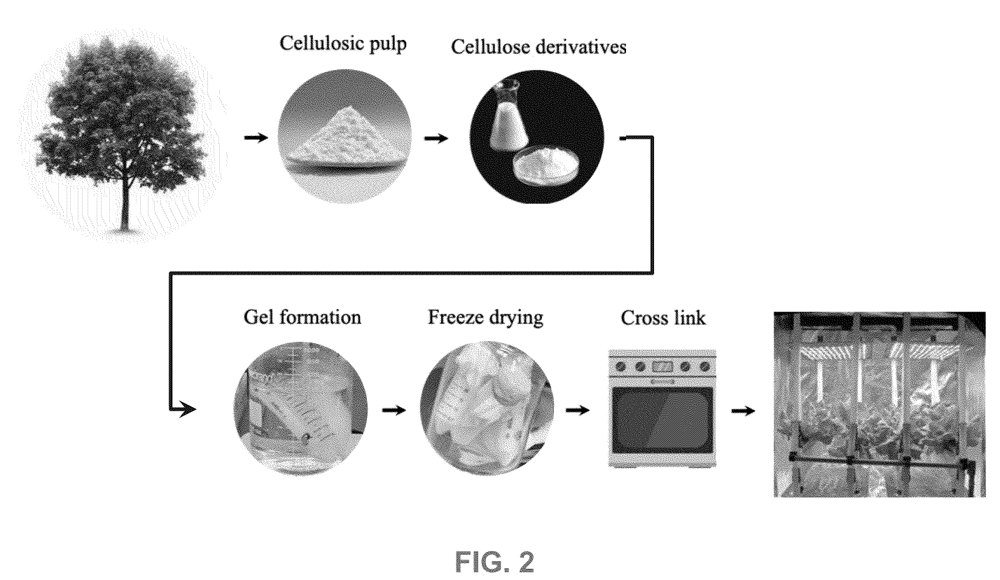

The resulting sample was composed of porous cellulose with citric acid dispersed throughout. The dried samples were crosslinked in an oven and the excess, uncross-linked citric acid was removed through water dialysis. Dialyzed samples were lyophilized for long-term storage (FIG. 2). The porous structure was confirmed under scanning electron microscopy (SEM). Furthermore, by controlling concentrations of cellulose and citric acid, pores even greater than 1 mm in diameter were able to be produced (FIG. 3). Because the dried sample looked soft and fluffy, the sample was given the name “cellulose sponge”.

Water-retention property: Cellulose is well-known for its water-retention properties, which benefit plant growth. Three cellulose derivatives were tested which sequentially have more to less hydrophilicity: hydroxyethyl cellulose (HEC), hydroxyethyl methylcellulose (HEMC), and hydroxypropyl methylcellulose (HPMC). This was done to identify whether different hydrophilicity impacts the water-retention property. When HEC, HEMC, and HPMC sponges were prepared with the same ratio of cellulose to citric acid by weight, large volumes of water were able to be absorbed in each sponge. When the dried HEMC and HPMC sponges absorbed water for an hour, their weight increased by 3,000˜4,000% when compared to the dry weight of the sponges while the HEC sponge increased up to 1,000%. The water-retention capability of those sponges was re-tested after the water fully evaporated. It was identified that HEC and HEMC sponges fully absorbed the same volume of water while the water absorption of HPMC was reduced by three times compared to its initial water absorption percentage. It was further observed that the water-retention properties of the sponges had no significant change between the different molecular weights of HEC and HEMC. Therefore, it was concluded that the difference in hydrophilicity among cellulose derivatives affects the maximum water volumes that can be absorbed into dried cellulose sponges and the reproducibility of water retention after the sponge dries out. Based on this conclusion, more focus was placed on HEMC and HEC sponges.

Durability: The durability of the HEMC sponge was evaluated via a cyclical water dehydration-rehydration test. Dried HEMC was hydrated for an hour and the swelling % was calculated by subtracting its dried weight from the wet weight. Then, the wet sponge was dried for 24 hours. This assessment was repeated for a month (FIG. 4). The data indicates that the water-retention capability of the HEMC sponge gradually decreased but still maintained >75% of its swelling ability (i.e., ˜3,000%) over a month, confirming the durability of the developed HEMC sponge.

Low density and malleability: The density of the cellulose sponges was measured to understand whether it is lightweight compared to commercially available, lightweight plant growth systems (e.g., Rockwool®). The volume of each dried cellulose sponge sample was determined by Polyga C506 3D Scanner and the FlexScan3D software. The calculated density (=weight/volume) of HEC and HEMC sponges was 130.7 kg/m³ and 17.6 kg/m³, respectively. The density of lightweight Rockwool®, a commercially available material for plant growth, is ˜25 kg/m³. This means that the developed HEMC sponge is 30% lighter than the commercial product, while the HEC sponge is four times heavier. This could be due to the difference in hydrophilicity between HEC and HEMC where more hydrophilic HEC allowed citric acids to access the hydroxyl group in HEC, resulting in more crosslinking between HEC. This was evidenced by the compressive modulus of the dried HEC sponge, ˜100 Pa which is around three times greater than the modulus of HEMC, ˜30 Pa. Based on the obtained data, it was concluded that the developed HEMC sponge is an impressive lightweight material for plant growth and that the low density of the sponge material provides the malleability to easily fit into any shape of the mold.

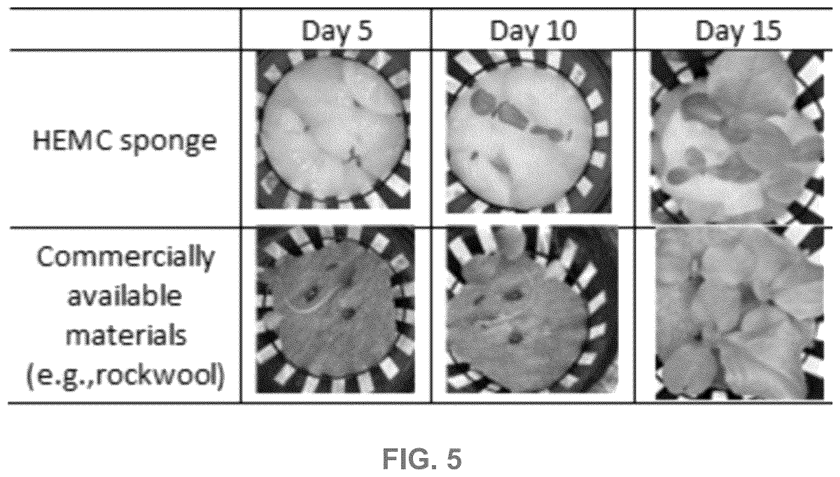

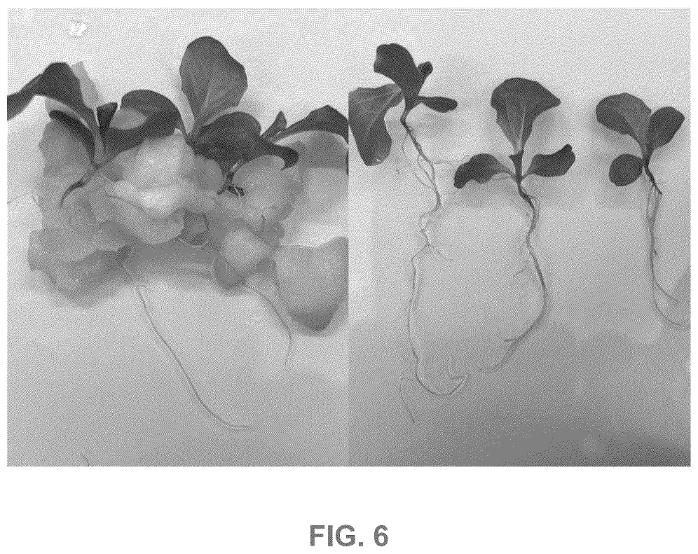

Performance: To evaluate the performance of developed cellulose sponges, pick-and-eat crops, such as lettuce, were grown and the results were compared to a Rockwool® system. Water and nutrients were constantly provided to the testing materials and the germination was observed for 2 weeks (FIG. 5). This experiment was repeated nine times (n=9). Leaf numbers per seed, leaf size (e.g., longest length), and root length were measured in each trial. Average leaf numbers per seed were 4 and 3, average leaf lengths were 2.5 cm and 3 cm, and average root lengths were 4.5 cm and 4 cm for the HEMC sponge and Rockwool®, respectively. During this assessment, it was confirmed that the HEMC sponge supported the plant growth and allowed the lettuce roots to penetrate the sponge. In addition, the roots were easily separated from the material (FIG. 6). While it is difficult to currently determine which material system showed better performance growing lettuce, it is known that commercially available low-density substrates used for plant growth (e.g., Rockwool®, floral foam) have a common drawback: they pose a threat to the respiratory system due to the material releasing lots of dust and loose fibers into the air, which is dangerous to humans in closed environments. Due to the crosslinked nature of the cellulose sponges, there is no threat to the respiratory system and the sponges have lower density and high water-retention properties, unique advantages of the cellulose sponge.

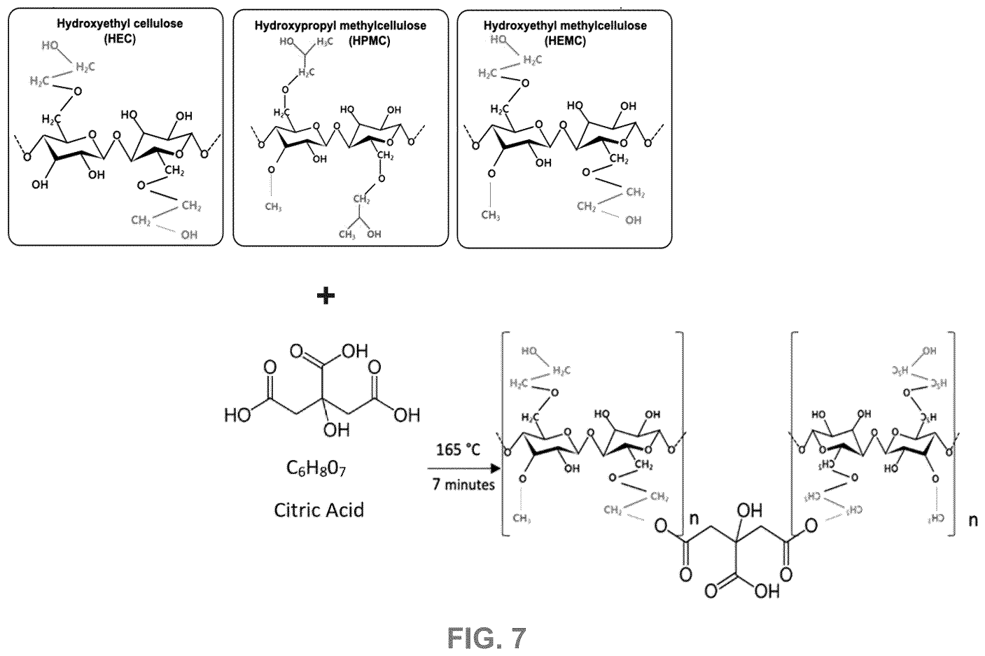

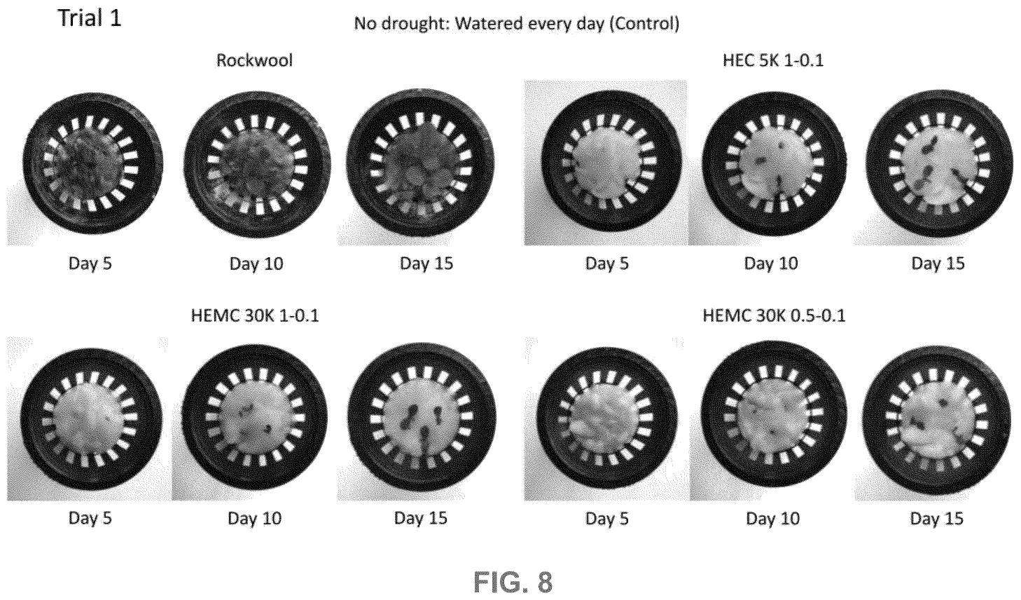

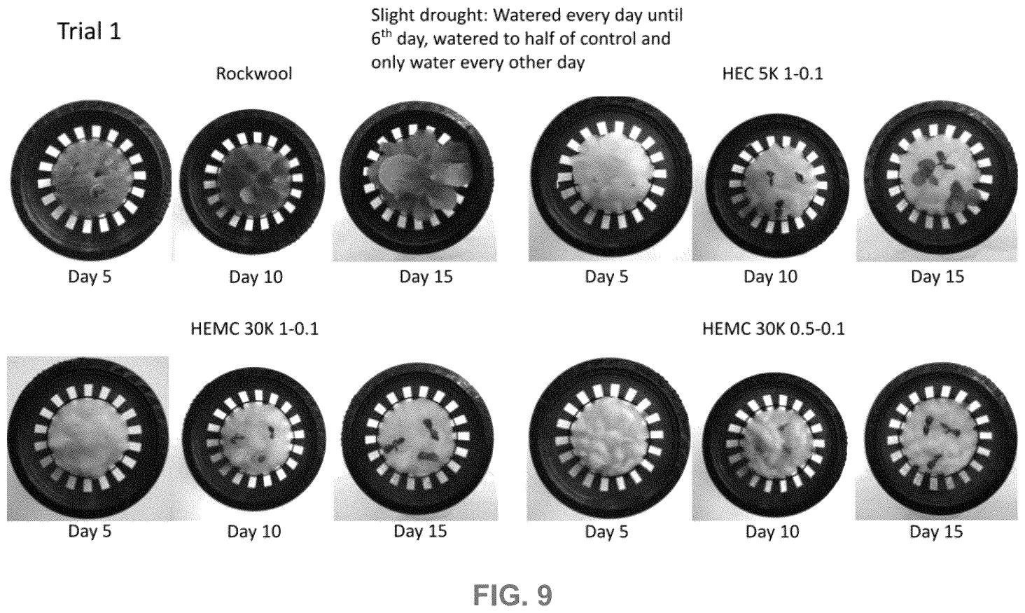

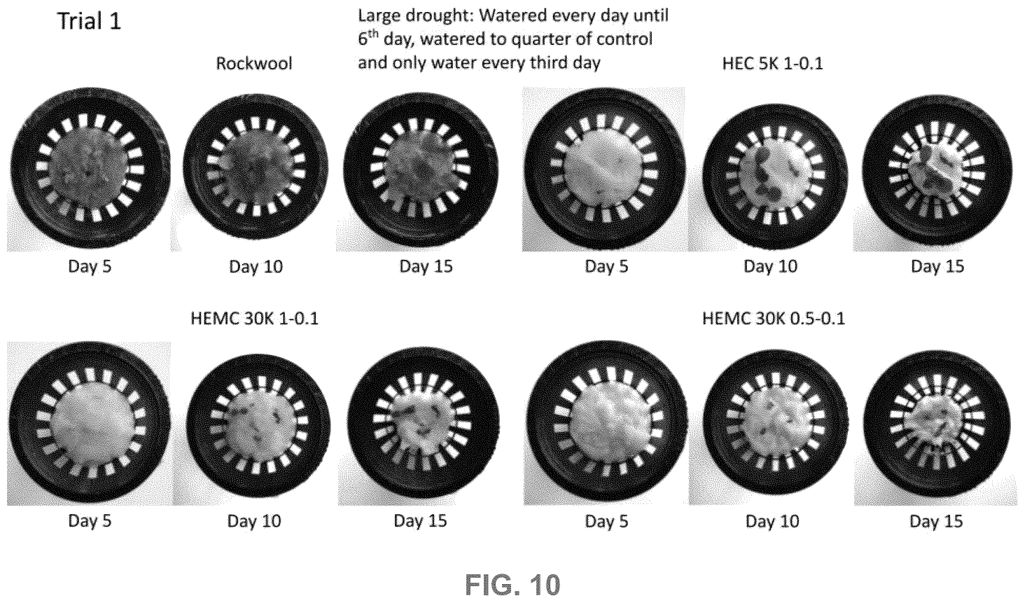

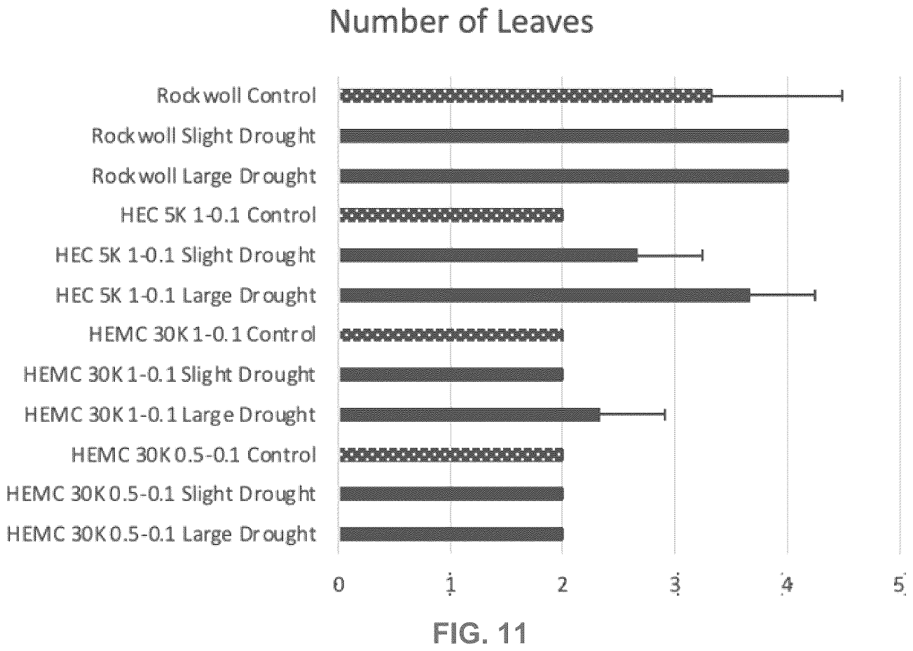

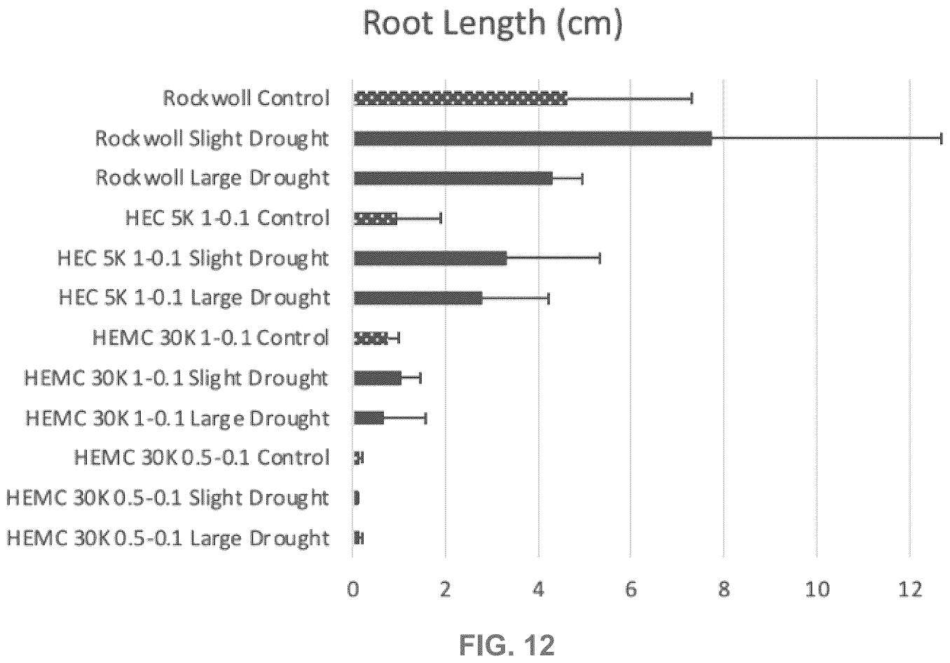

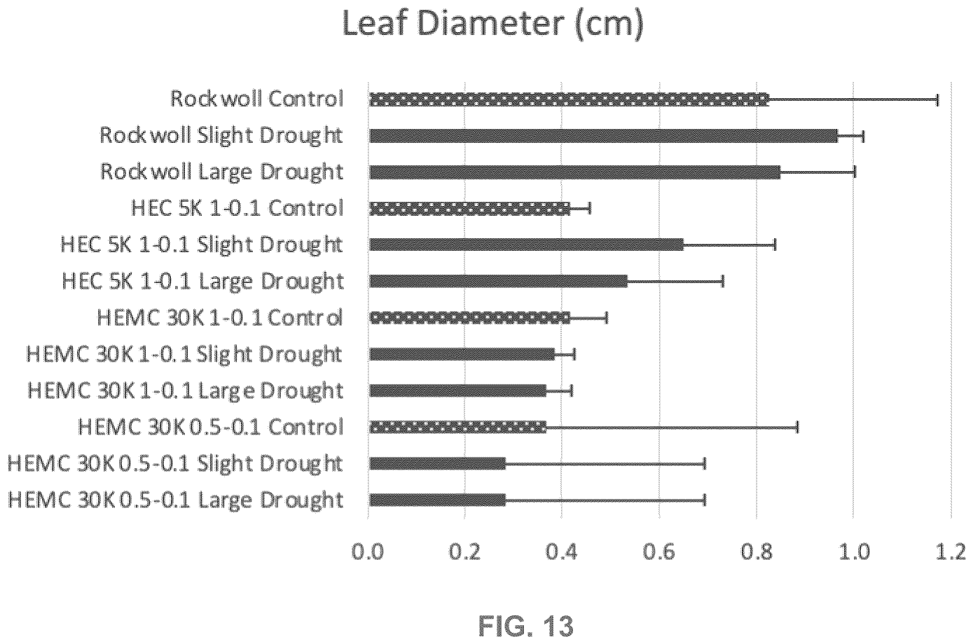

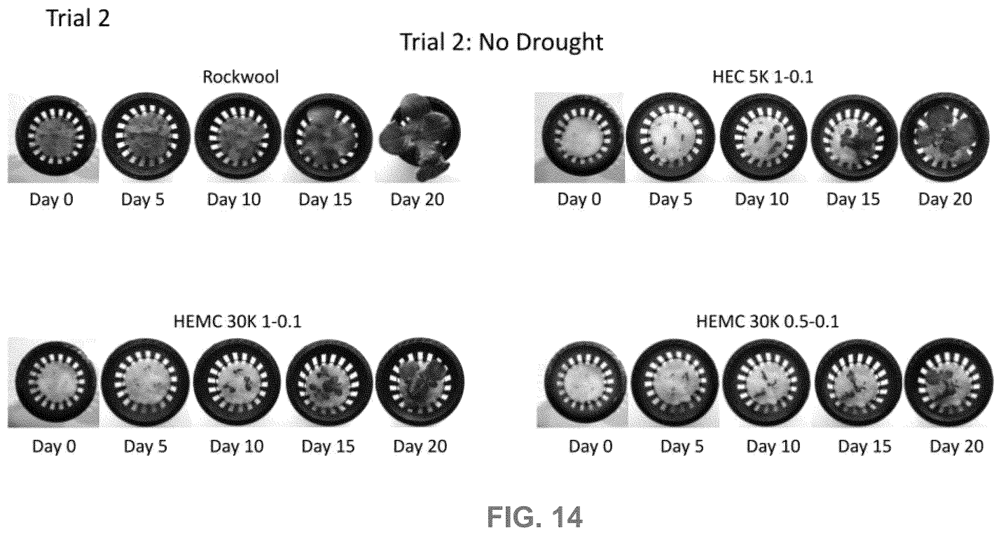

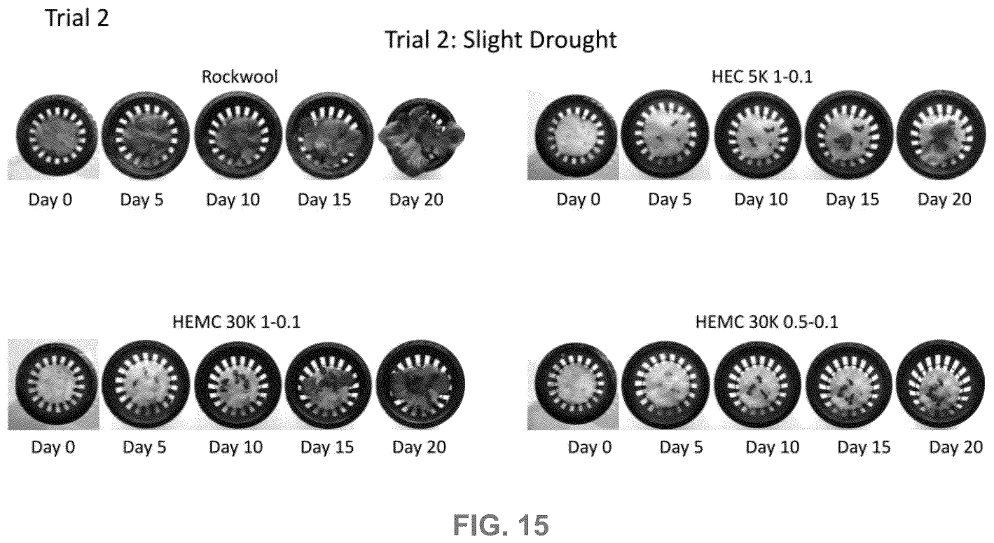

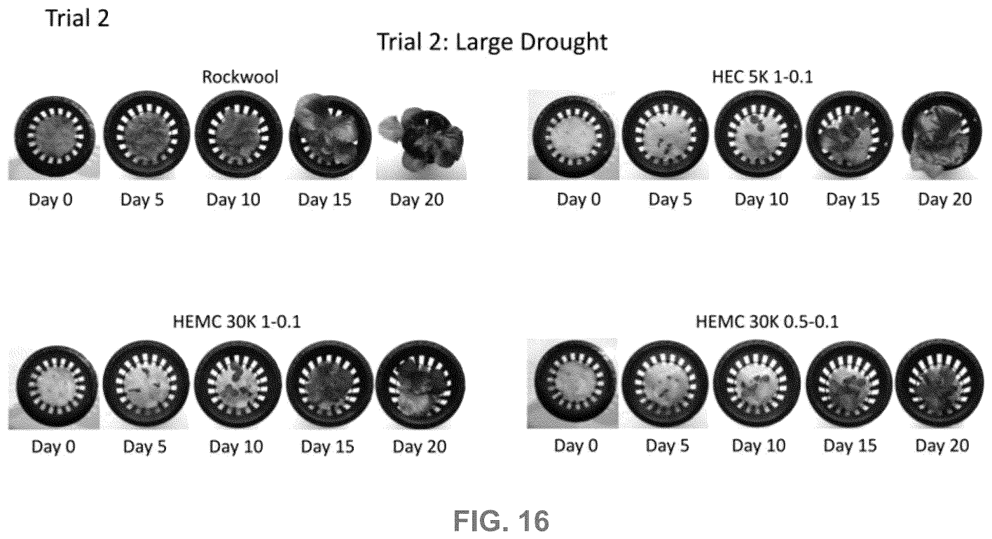

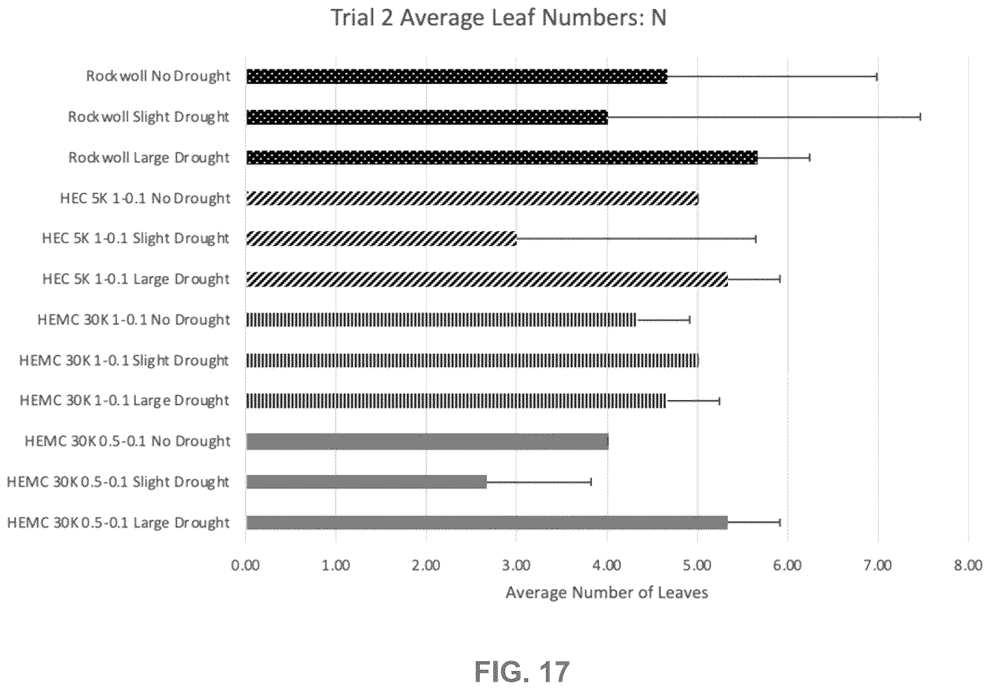

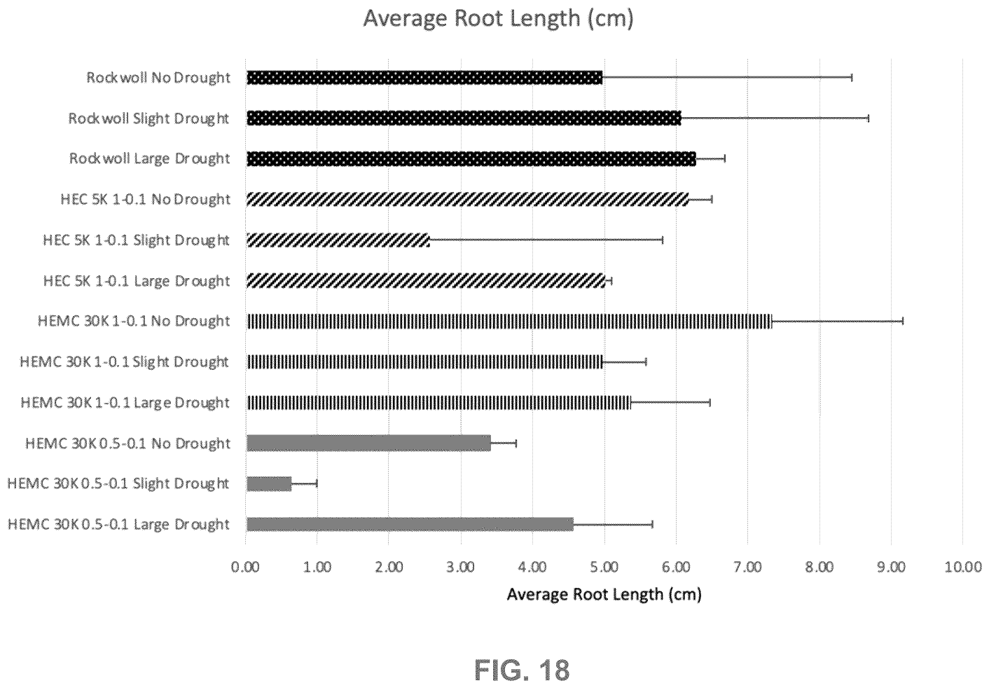

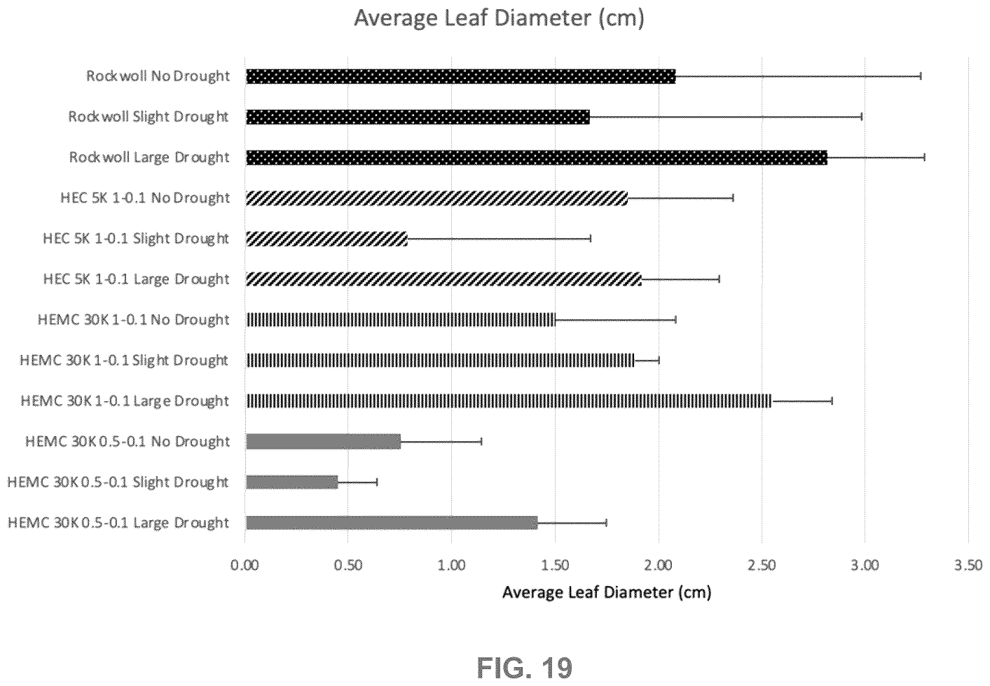

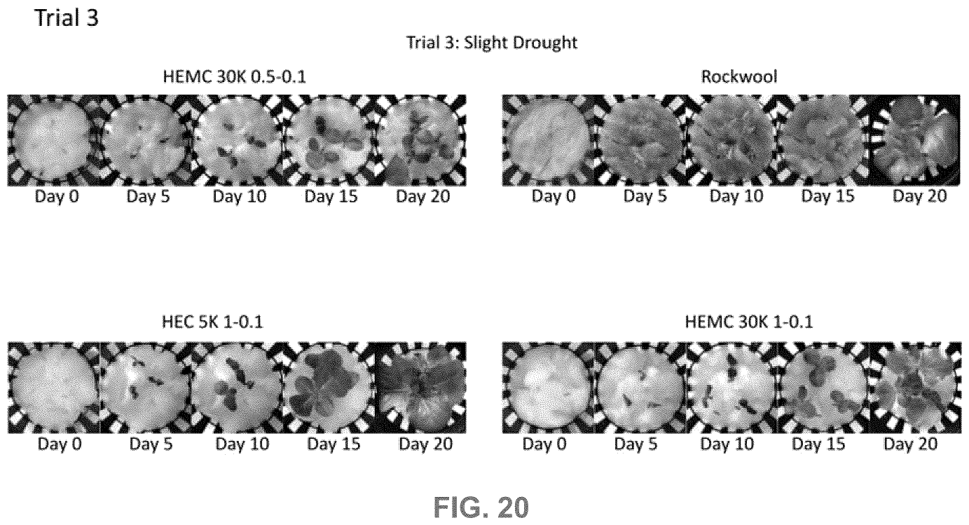

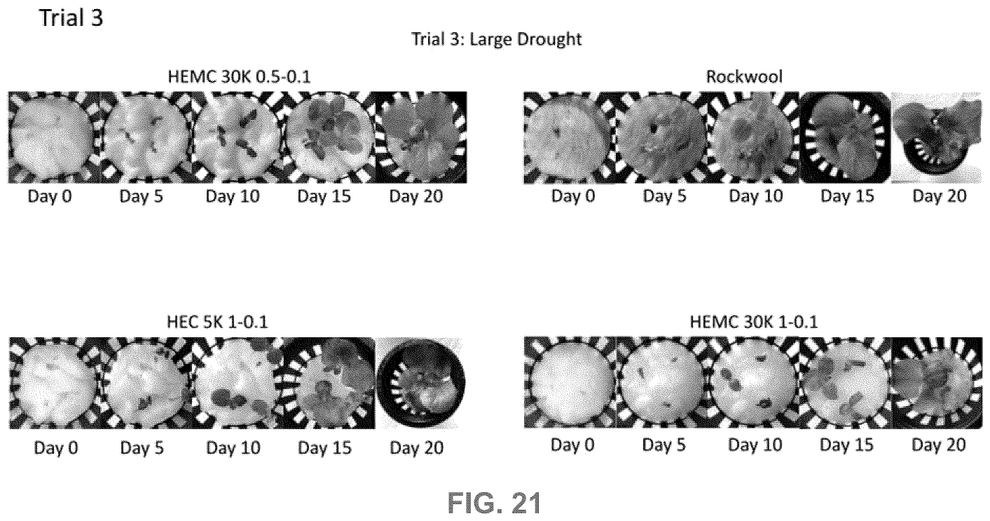

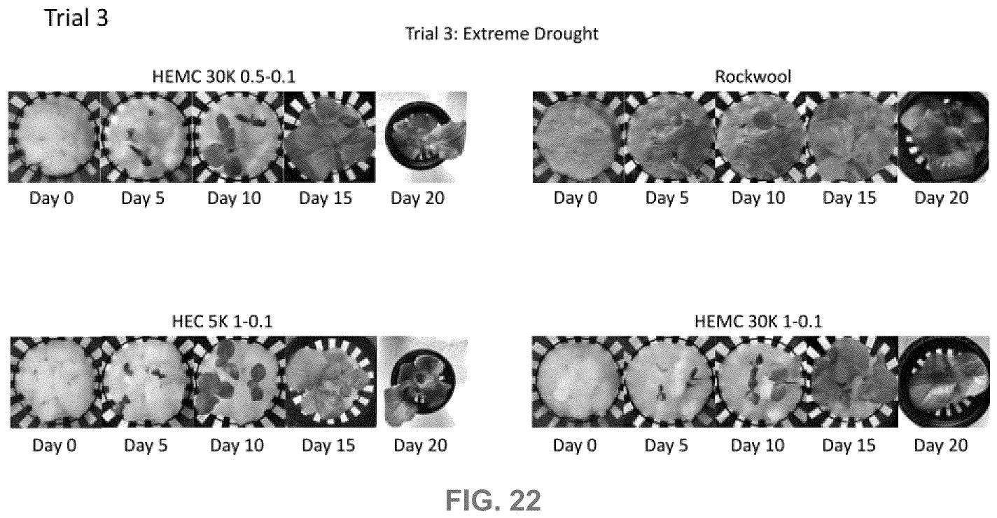

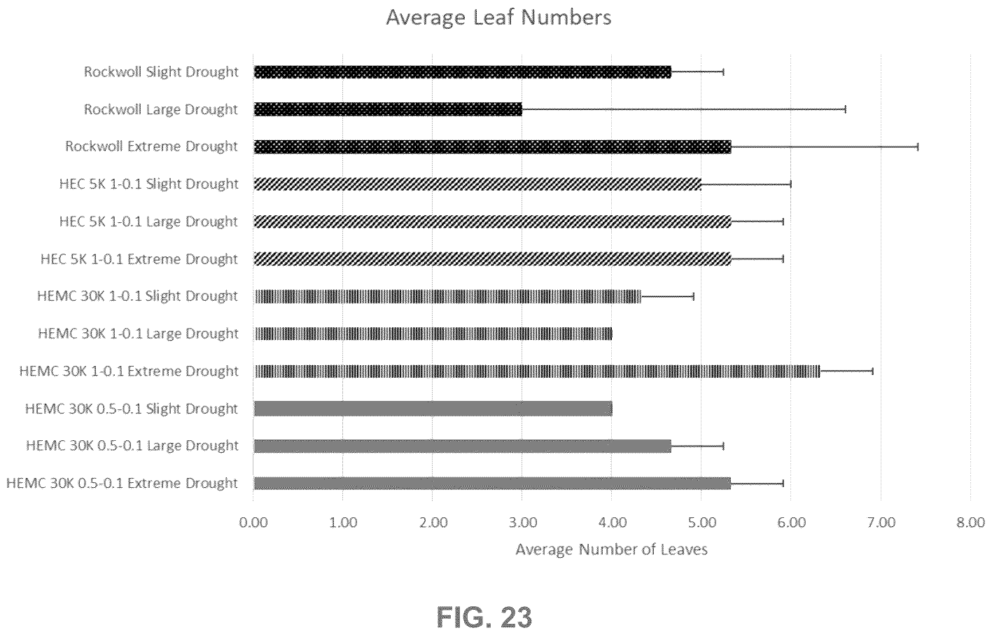

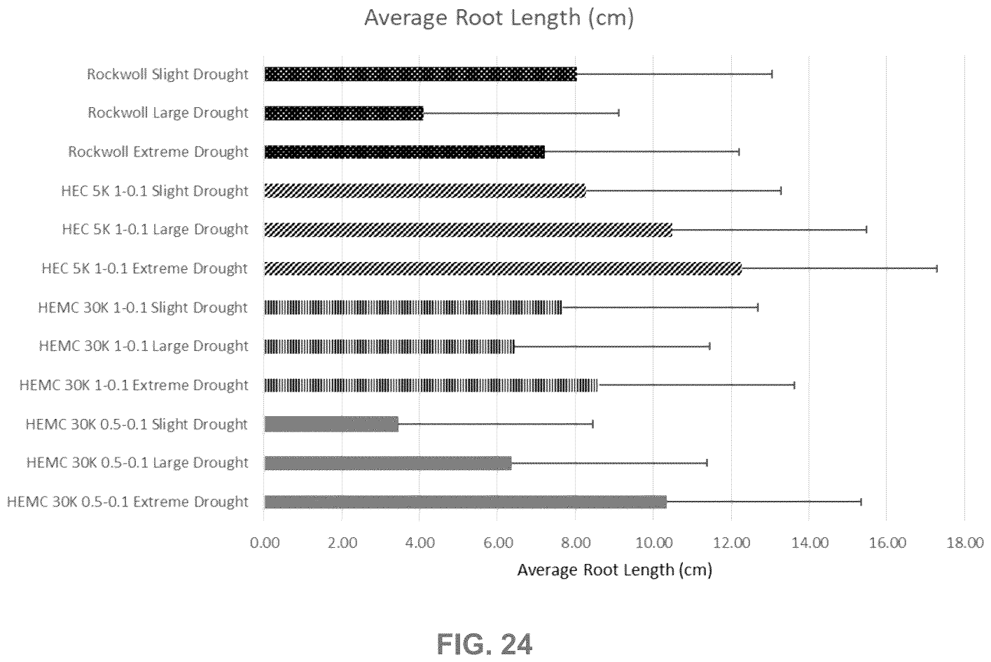

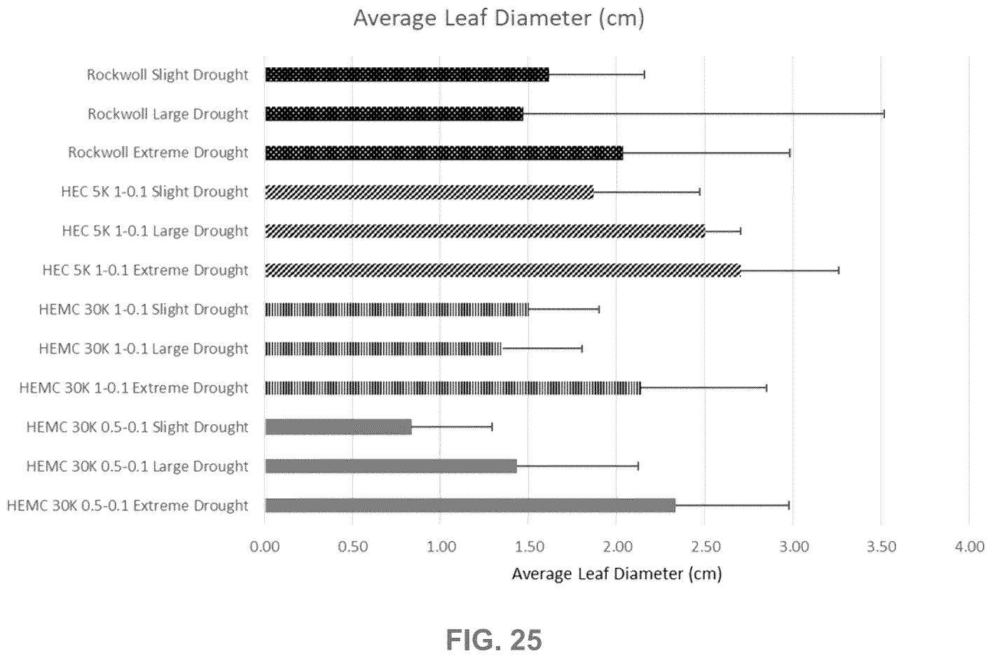

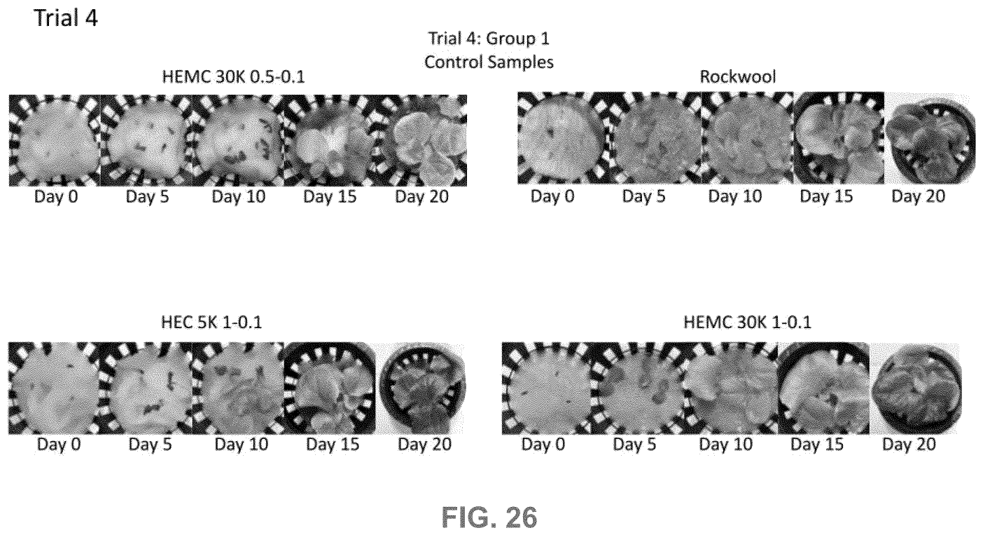

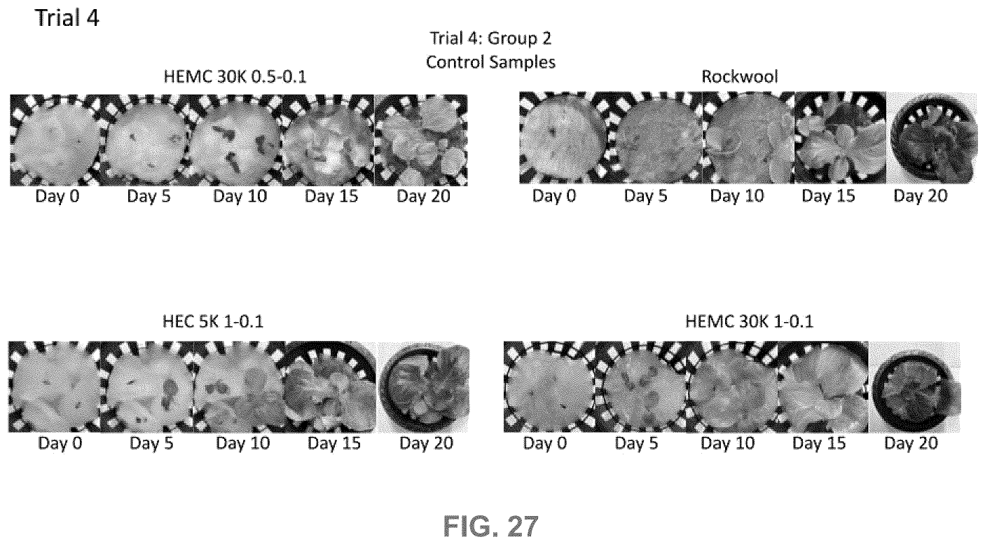

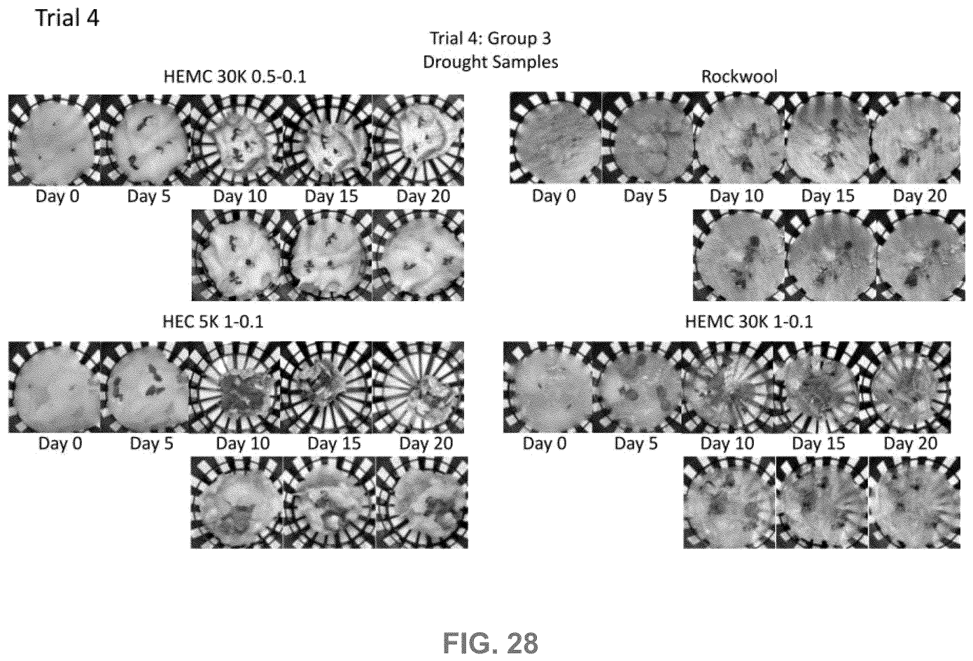

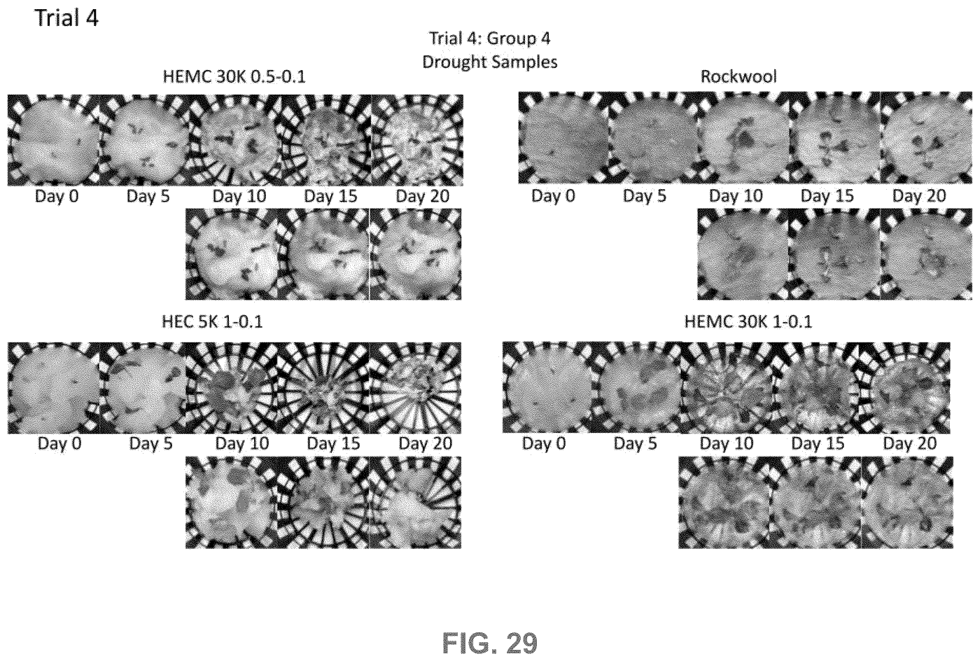

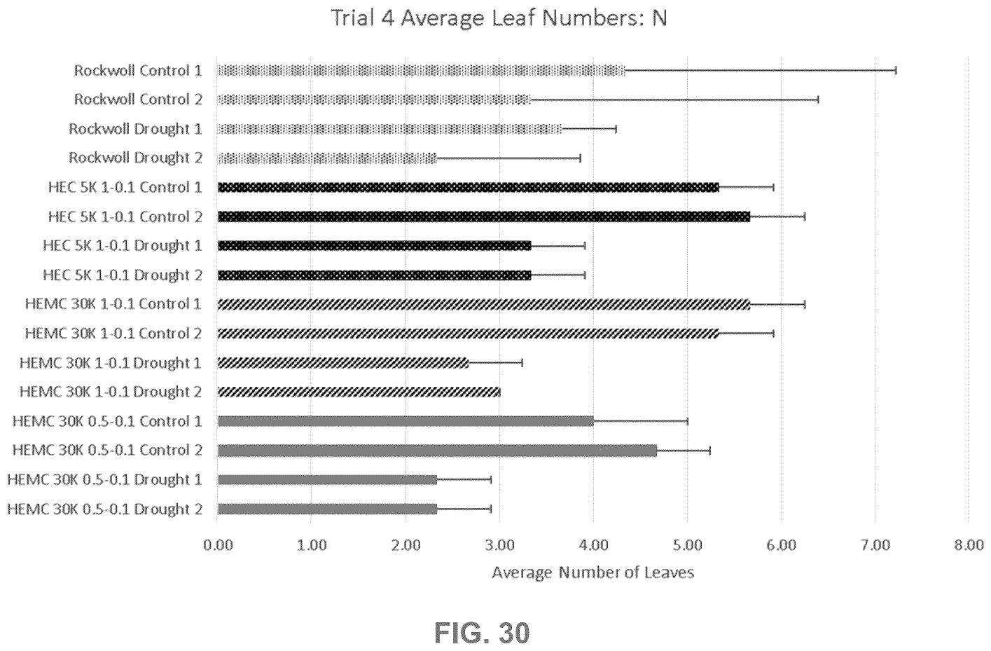

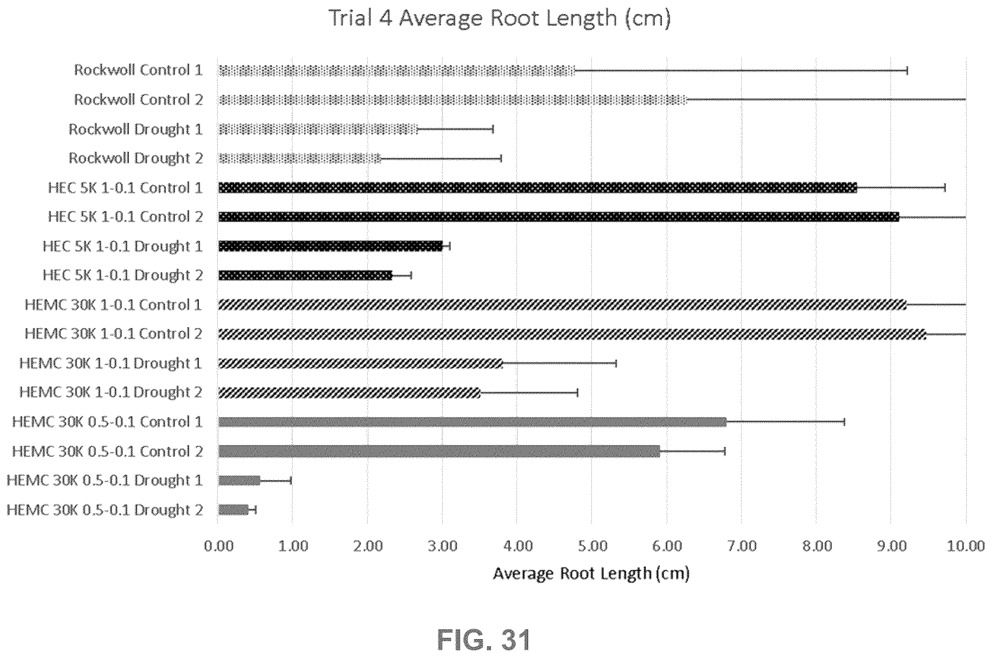

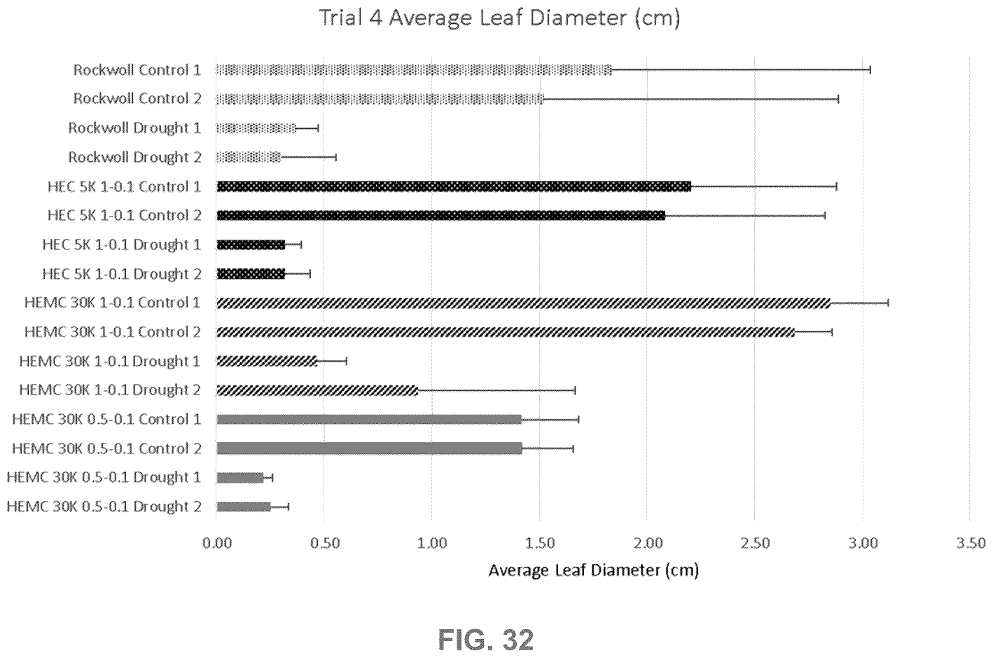

EXAMPLE 2: NASA tasked a select few schools, institutes, and industries around the country to produce a material to grow plants in extreme environments. Over the course of several years, teams of researchers at the University of Arizona designed and developed a cellulose sponge material capable of meeting or exceeding the performance of commercially available Rockwool® in weight, plant growth, and water retention. Cellulose is the most abundant biopolymer on earth. From trees to grass, all plants on earth contain cellulose. By taking plants and refining the cellulose from them, companies have been able to produce fine cellulose powders in various different forms. As shown in FIG. 7, the three cellulose derivatives focused on for this stage of testing are Hydroxyethyl Cellulose (HEC), Hydroxyethyl Methyl Cellulose (HEMC), and Hydroxypropyl Methylcellulose (HPMC). The differences between the cellulose are small but important. HEC are hydrophilic while HPMC are hydrophobic when comparing those three types. The hydrophilicity and hydrophobicity of HEMC is between HEC and HPMC (see FIG. 7). Preliminary dehydration and rehydration testing of the three cellulose types concluded HEMC and HEC cellulose types are able to bounce back from repeated cycles of dehydration and rehydration with little impact to total water retention properties.

The materials for sample preparation were HEMC-30K cellulose, HEC-5K cellulose, citric acid, a scale, beakers/test tubes, a hot plate, a stir bar, liquid nitrogen, lyophilizer, an oven, dialysis buckets with deionized water, and pH testing strips. The materials for testing were cellulose sponge samples, a plastic tray, 1.5 inch diameter plant pots (12 for each test), 8 grow lights, a timer switch, a cardboard box to cover apparatus, lettuce seeds, nutrient solution, a camera, a ruler, and Rockwool®.

Making the cellulose sponge: The amount of cellulose and citric acid needed for the type of cellulose needed was determined. An Erlenmeyer flask or beaker was rinsed with deionized water to ensure that it was clean. The goal was a ratio of cellulose derivatives: citric acid of 100:1 to 1:1, and a cellulose concentration in water from 0.1% to 15% of weight per volume of water. The amount of necessary water was determined and the beaker was filled to that amount using deionized water. The beaker was boiled on the hot plate in the range of 60° C. and 80° C. After cleaning with ethanol and wipes, the thermometer and stirring bar were placed in the beaker. Weigh paper and a scale were used to measure out citric acid first. The amount of citric acid depended on the concentration being made. Citric acid was added to the water and allowed to fully dissolve before adding the cellulose.

Table 1 below details the amounts of water, cellulose, and citric acid needed to prepare each sample that was used in this test. The proportions can be scaled if a larger or smaller sample is needed.

| Cellulose Type | Water | Cellulose | | Citric Acid |
|---|---|---|---|---|
| HEC 5K 1-0.1 | 100 mL | 1 | g | 100 mg |
| HEMC 30K 1-0.1 | 100 mL | 1 | g | 100 mg |
| HEMC 30K 0.5-0.1 | 100 mL | 0.5 | g | 100 mg |

The cellulose was weighed out using the same method as the citric acid. The cellulose was slowly added to the beaker so as not to form clumps. The cellulose was stirred until it was dissolved, but not too rapidly as this would form bubbles that would remain in the sample. The beaker was placed in the center of the hot plate so the stir bar mixed the liquid evenly and the mixture became homogenized. The beaker was moved around and the stir speed was increased to let the stir bar break up any chunks. After the mixture was homogenized with no chunks, it was transferred over to the stirring station next to the hot plate. The liquid was allowed to mix for a few minutes, avoiding making bubbles with the stir bar.

The beaker was then covered with foil or plastic wrap and transferred into the fridge to allow the temperature to drop. The sample was homogenized in the fridge for an hour or room temperature overnight with the stir bar at about 160 rotations per minute. If any remained, the sample needed to be homogenized further. After the sample was homogenized, it was then frozen with liquid nitrogen. The frozen sample was then placed into the lyophilizer.

Lyophilizer: The lyophilizing processor removed all the water from the frozen samples at −80° C. with a vacuum between 0-200 mT. Liquid nitrogen was poured into the test tubes to freeze the samples. The samples were then placed in a lyophilizer jar and the jar was attached to the rubber lids of the lyophilizer. The lyophilization process was run until the samples were completely dry, which took approximately 1 to 3 days.

Crosslinking: Once finished with the lyophilizer, the next step was to crosslink the mixture of dried cellulose and citric acid. The samples were placed in the oven for ˜5 minutes at ˜160° C.

Dialysis: The purpose of the dialysis of crosslinked cellulose sponge is to remove residual, uncrosslinked citric acids. After the water dialysis of the cellulose sponge in a beaker with 160 rpm or below for several hours, pour the water and the sample was poured onto a paper towel and dabbed a few times to remove excess water. A pH strip was held on the sample for a few seconds to check the pH. If the pH was not above 5.5, the dialysis process repeated.

EXAMPLE 3: This is the general experimental setup that was used for all of the experiments. Further details on the specifics of each experiment are in the paragraphs following this procedure: Disinfect a growing tray and plant pots under a UV lamp; set up growing tray; attach 4 red and blue plant grow LED lights to each tray and place a divider between each light; connect the lights to a power strip on a timer set to 18 hours on and 6 hours off; for each sample type being tested, place a 1-3 cm layer of the cellulose sponge into the plant pot; make 4 pots of each sample for each growing tray; using sterilized tweezers, place 3 lettuce seeds per pot just under the surface of the cellulose sample; arrange the pots in rows in the growing tray, with one type of sample per row and each row separated by a divider; and add nutrient solution to the tray up to half of the sample height. For the first 5 days, water remained in the tray for all samples. After 5 days, the conditions were changed depending on the experiment, which will be discussed more in the following paragraphs. Cover the apparatus with the cardboard box to prevent outside light and contaminants from reaching the samples; every 5 days, take photos of each pot; after 20 days, measure the number of leaves, leaf diameter, and root length for each pot.

In trial 1, Rockwool®, HEC 5K 1-0.1, HEMC 30K 1-0.1, and HEMC 30K 0.5-0.1 were tested under three different conditions: no drought, slight drought, and large drought. For HEC 5K 1-0.1, 5K means 5,000 mPa·s as viscosity of HEC, 1 means 1% weight per volume of HEC, and 0.1 means 0.1% weight per volume of citric acid. This pattern is mirrored for HEMC 30K 1-0.1, and HEMC 30K 0.5-0.1. The no drought (control group) was watered every day to half of the sponge height. This group was the control group and was repeated in every future trial. The slight drought group was watered every day for the first 5 days to allow the seeds to sprout, and then after the 5th day was watered every other day. This resulted in the water level decreasing by half. The large drought group was similarly watered every day for the first 5 days, and then watered every third day, which decreased the water level by ¾. This experiment only ran for 15 days, as opposed to 20 days in all the future trials.

In trial 2, the following was changed from trial 1: the experiment increased to 20 days, seeds were placed just under the surface of the sponge instead of buried inside to aid with germination and the severity of the drought was increased. This time, the slight drought group was watered every other day but only to ⅓ of the sponge height. The large drought group was watered every third day to ¼ of the sponge height. The control group remained the same as trial 1. The experimental setup remained the same, and the same 4 samples were tested (Rockwool®, HEC 5K 1-0.1, HEMC 30K 1-0.1, and HEMC 30K 0.5-0.1).

In trial 3, an even more severe drought was tested because after trial 2 it was found that the plants with less water grew better, so the plants may have been overwatered. The control group was changed to the slight drought from previous trials, where the plants were watered every other day since that group performed better than the original control. The second group was the large drought group from trial 2, where the plants were watered every third day. The new test in trial 3 was the extreme drought, where the plants were watered every fifth day. Other changes from trial 2 were a new growing tray with grooves that allowed the water to touch more surface area of the sample and allowed the roots to grow more freely. The other change was that the position of the plants in the tray was shifted to account for variance in the brightness of the grow lamps so that one sample did not receive false better results if it was in the brighter region of the grow lamp.

In Trial 4, the goal was to test the extreme case where the plants have no water to see how well the cellulose sponge performs in extreme conditions, and how well it is able to rehydrate. Complete drought was simulated for HEMC 30K 1-0.1, HEMC 30K 0.5-0.1, HEC 5K 1-0.1, and Rockwool®. After 5 days of regular watering, the experimental groups of cellulose and Rockwool® were subjected to a harsh drought where all water was completely removed from the trays for 5 days straight. After 5 days, the samples were rehydrated by soaking them in water for one hour. The samples were photographed immediately before and after rehydration to compare. The wet samples were placed back in the tray but no additional water was added to the tray. The control group constantly had water in the tray that was maintained at ⅓ of the sponge height, as in trials 1 and 2.

### RESULTS

From trial 1, it was determined that Rockwool performed the best in all of the experiments: It had the highest number of leaves, root length, and leaf diameter of any of the samples tested for all of the drought levels. None of the cellulose samples performed very well, but it was determined that this was due to the seeds being placed too deep inside the cellulose. Overall, none of the plants (cellulose or Rockwool®) grew very well and they all had low values for leaf number, root length, and leaf diameter. This led to the conclusion that the plants were being overwatered, so the amount of water was decreased for the next trial. Another possible reason that the plants didn't grow very well is that the pH of the samples was too low. After the trial, it was measured to be 5-5.5, but it should be 5.5-6 to grow lettuce. This was fixed by doing more dialysis before the next trials.

For trial 2, two major changes were implemented based on what was learned from trial 1. The first was to put the seeds on top of the cellulose sponge, only covered by a thin layer of the sponge, instead of buried inside. This was to aid with germination and get the plants to sprout earlier. The second change was the drought severity was increased, watering to only ⅓ and ¼ of the sponge height for the two drought trials. In trial 2, all of the plants grew much better and had larger leaf numbers, root length, and leaf diameter than their counterparts from trial 1. This shows that the assumption about the plants being overwatered was correct. However, the plants may still be receiving too much water because the group with the least amount of water grew the best. For the next trials, the water level was reduced to ¼ of the sponge height as it was in the large drought group of trial 2, and the watering interval was changed. The large drought cellulose samples performed equally as well and had values comparable to Rockwool® for leaf number, root length, and leaf diameter.

This is a win for the cellulose sponge because it shows that the sponge thrives in drought conditions. This makes it ideal for growing crops in space because there are limited resources in space and the goal is to use as little water as possible. Further proving this point, the cellulose samples from the large drought group (specifically HEC 5K 1-0.1 and HEMC 30K 1-0.1) had result values the same as or slightly better than the control group Rockwool®. This shows that the same result and amount of growth can be achieved with less water by using the cellulose sponge instead of Rockwool®, which would conserve resources on the spacecraft. Another observation is that all of the Rockwool® samples had a plant die or not germinate at all, whereas in the cellulose samples, all three seeds germinated every time. This shows that the cellulose sponge has a higher success rate at sprouting the plants than Rockwool®, which is important in space where there are a limited number of seeds available so all the seeds must sprout for better yield.

For trial 3, the plants were watered even less to further test the overwatering hypothesis. One group was watered every other day, one group every 3 days, and one group every 5 days. The extreme drought group that was watered every 5 days performed better than the other drought groups across all categories for all the cellulose sponges, which proves the hypothesis that the plants were being overwatered. It was determined that the cellulose sponges work best when there is minimal water. One very promising observation is that this was the first trial where the cellulose sponges performed better than Rockwool®. For the extreme drought group, all the cellulose sponges had higher numbers for leaf number, root length, and leaf diameter than the Rockwool® samples in that group. This shows that the cellulose sponge not only grows better but uses less water than Rockwool®, which makes it an overall better choice than Rockwool® for plant growth in space.

Trial 4 aimed to test the extreme case where the plants are in complete drought with no water in the tray, and only the water in the sponge available to the plants. Predictably, this resulted in significantly stunted plant growth compared to the previous trials, but it brought some interesting observations. Most notable was the effect of hydrophobic or hydrophilic properties and crosslinking density of the cellulose sponge on water retention and drought performance. HEMC 30K is both hydrophobic and hydrophilic, while HEC 5K has hydrophilic properties. In the trials, both HEMC 30K 1-0.1 and HEMC 30K 0.5-0.1 were tested. The difference in crosslinking density of the HEMC 30K sponges is determined by the ratio of cellulose to citric acid. HEMC 30K 1-0.1 has a ratio of 10:1, 10 mg of cellulose per 1 mg of citric acid while HEMC 30K 0.5-0.1 has a ratio of 5:1.

During processing, all samples were placed in an oven at 165° C. and baked for 7 minutes. In the presence of heat, citric acid crosslinks cellulose so the ratio of cellulose to citric acid is pertinent to the crosslinking density. HEMC 30K 0.5-0.1 has half the ratio of cellulose to citric acid than HEMC 30K 1-0.1, therefore, the crosslinking density of HEMC 30K 0.5-0.1 is greater than that of HEMC 30K 1-0.1. Preliminary rheology tests provide evidence for the link between crosslinking density and rigidity. Pictures of the drought samples in trial 4 show the impact of crosslinking density on the material's ability to keep the plant alive, and the material's ability to recover its original shape after drought conditions. HEMC 30K 0.5-0.1 was able to keep the plants alive after three cycles of 5 days of drought. These results are indicative of the material's ability to retain moisture over long periods of time. HEMC 30K 0.5-0.1 shrinks when water is not present for long periods of time, but what sets HEMC 30K 0.5-0.1 apart from HEMC 30K 1-0.1 is 0.5-0.1-s. If moisture was not retained in the cellulose, the plants would have died. This is what happened for the Rockwool® samples. The plants showed signs of discoloration on day 15, which is two cycles of 5 days of drought. Rockwool® is porous and dries up quickly, leaving little to no moisture available for the plants to use. Rockwool performs poorly in a drought environment.

An unexpected result from trial 4 was the growth of algae in the water, which can be seen as a green film on the samples. It was determined that this contamination must have come from the nutrient solution since it was prepared at an outside site. Everything used in the lab was sterilized with ethanol and/or a UV light before use, so the contamination must have come from the water jug or the water itself. Despite this, there did not seem to be a significant effect on plant growth. This shows that the cellulose sponge can withstand extreme conditions and still support life.

Information gathered from testing the cellulose in a full drought environment provides useful insight into the way in which the cellulose sponges behave. HEC contains hydroxyethyl groups which are hydrophilic. This allows this cellulose derivative to exhibit additional hydrophilic properties. Hydrophilic properties allow the cellulose to crosslink to a high degree due to the water-soluble citric acid diffusing deep into the cellulose mixture before lyophilizing, (i.e., freeze-drying). As the degree of crosslinking in the cellulose sponge increases, the sponge holds lower volumes of water. High degrees of crosslinking caused the pores of the cellulose to shrink and become rigid which reduces the pores' expansion capabilities in the presence of water. There is a direct link between crosslinking numbers and the rigidity and density of the cellulose sponges. HEMC contains hydrophilic and hydrophobic groups, therefore, the diffusion of dissolved citric acid into the cellulose mixture is slightly resisted. This results in the HEMC cellulose sponge experiencing a lower degree of crosslinking, larger pore sizes, increased water retention volumes, lower density, and lower rigidity as compared to the HEC cellulose sponge.

After four rounds of drought testing, HEMC 30K 0.5-0.1 was found to have the best material properties for drought tolerance. Trial 4 displays the capabilities of HEMC 30K 0.5-0.1 better than any of the other trials. For the cellulose sponge to be suitable for plant growth, it must be capable of full rehydration with little to no net shrinkage after experiencing complete dehydration. HEC 5K 1-0.1 is also a contender, but the results from trial four indicate possible issues with HEC 5K 1-0.1 in terms of its ability to rehydrate to its original size. The net shrinkage on the HEC 5K 1-0.1 is estimated to be around 25% compared to the fully hydrated sample. HEMC 30K 1-0.1 turned out to be the worst sample. After the first complete drought in Trial 4, HEMC 30K 1-0.1 failed to rehydrate. The sponge turned into a thin wafer after dehydration and no amount of rehydrating allowed for the material to recover. The reason for the loss of rehydration abilities stems from the degree of crosslinking. HEMC 30K 1-0.1 has twice as much cellulose as HEMC 30K 0.5-0.1.

The increased amount of cellulose relative to citric acid caused the HEMC 30K 1-0.1 sponges to have a lower degree of crosslinking. Which means the pores are larger but weaker. The dehydration of the sponge allowed the weak pores to close completely, preventing any chance of rehydration. The rigidity of the cellulose sponge is integral to the rehydration performance. Rockwool failed to provide water and nutrients to the plants soon after the full drought began. Rockwool® is porous but it does not retain water nearly as efficiently as the cellulose sponges. The water absorbed in the Rockwool® quickly evaporated causing the plants to dry up and die after two rounds of drought tests. Both HEC 5K 1-0.1 and HEMC 30K 0.5-0.1 were able to supply the plants with water for as long as possible, allowing the lettuce to remain alive after three rounds of drought. The surviving lettuce was close to dying but with proper care it is likely that a full recovery could happen. Under the basis of keeping crops alive in severe drought environments, trial four clearly points towards the outperformance of Rockwool® by both HEC 5K 1-0.1 and HEMC 30K 0.5-0.1.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A cellulose sponge (100) for supporting plant growth, wherein the cellulose sponge (100) is a product of cellulose derivatives (110) cross-linked with citric acid (120).

2. The sponge (100) of claim 1, wherein a ratio of the cellulose derivatives (110) to the citric acid (120) ranges from about 100:1 to about 1:1.

3. The sponge (100) of claim 1 comprising pores having a diameter ranging from about 0.01 to greater than 1 mm.

4. The sponge (100) of claim 1 having a porosity ranging from about 80% to about 95%.

5. The sponge (100) of claim 1, wherein the cellulose derivatives (110) comprise hydroxyethyl cellulose, hydroxyethyl methylcellulose, hydroxypropyl methylcellulose, or a combination thereof.

6. The sponge (100) of claim 1, wherein the citric acid (120) comprises food-grade citric acid.

7. The sponge (100) of claim 1, wherein the sponge (100) is configured to absorb water such that a weight of the sponge (100) expands by about 1000% to about 4000% over an hour.

8. The sponge (100) of claim 1, wherein a density of the sponge (100) ranges from about 17.6 to 130.7 kg/m³.

9. The sponge (100) of claim 1, wherein a lifespan of the sponge (100) under constant moisture is greater than one month.

10. A method of forming a cellulose sponge (100) suitable for supporting plant growth, the method comprising:
a. providing a cellulose or cellulose derivative (110);
b. providing a solution comprising citric acid (120) and water;
c. mixing the cellulose or its derivative (110) into the solution of citric acid (120) and water to create a cellulose-citric acid solution;
d. lyophilizing the cellulose-citric acid solution; and
e. heating the lyophilized cellulose-citric acid mixture to cause cross-linking of the cellulose derivative and citric acid, thereby producing the cellulose sponge (100).

11. The method of claim 10, further comprising removing unreacted citric acid from the cellulose sponge.

12. The method of claim 11, wherein the unreacted citric acid is removed by dialysis.

13. The method of claim 10, further comprising lyophilizing the cellulose sponge to remove water.

14. The method of claim 10, further comprising heating the solution of citric acid (120) and water to a temperature of about 60-80° C. while mixing in the cellulose derivative (110), thereby promoting mixture of the cellulose-citric acid solution.

15. The method of claim 10, wherein the cellulose derivative (110) and solution of citric acid (120) and water are stirred to prevent clumping.

16. The method of claim 10, wherein the lyophilized cellulose-citric acid mixture is heated to a temperature of about 120 to 200° C. for cross-linking.

17. The method of claim 10, wherein a ratio of the cellulose derivative (110) to the citric acid (120) ranges from about 100:1 to about 1:1.

18. The method of claim 10, wherein the cellulose sponge comprises pores having a diameter ranging from about 0.01 to greater than 1 mm.

19. The method of claim 10, wherein the cellulose derivative (110) comprises hydroxyethyl cellulose, hydroxyethyl methylcellulose, hydroxypropyl methylcellulose, or a combination thereof.

20. The method of claim 10, wherein the citric acid (120) comprises food-grade citric acid.
